(19) United States
(12) Patent Application Publication
(10) Pub. No.: US 2001/0035198 A1
(43) Pub. Date: Nov. 1, 2001

(54) Product recovery system

(75) Inventors: Roy Eugene Carawan, Apex, NC (US); Grant Frederick Smith, Lexington, NC (US)

Correspondence Address: SAUL EWING LLP, CENTRE SQUARE WEST, 1500 MARKET STREET, 38TH FLOOR, PHILADELPHIA, PA, 19102-2186, US

(73) Assignee: Gannett Fleming, Inc.

(21) Appl. No.: 09/812,508

(22) Filed: Mar. 20, 2001

Related U.S. Application Data
(60) Provisional application No. 60/190,628, filed on Mar. 20, 2000.

(51) Int. Cl. B08B 9/093

(52) U.S. Cl. 134/18; 134/22.18; 134/56 R; 134/166 R

(57) ABSTRACT

The present invention relates generally to a product recovery system for recovering residual product from processing food or feed in manufacturing facilities, and more particularly to a product recovery system for recovery of residual raw or processed food or feed from processing plant lines and equipment. The product so recovered is useful as an ingredient in further food or feed manufacture. The product recovery system provides the further utility of removing the residual product from the waste effluent stream of the manufacturing facility.

This application claims the benefit of copending U.S. Provisional Application No. 60/190,628, filed Mar. 20, 2000, the subject matter of which is incorporated by reference in its entirety.

### FIELD OF THE INVENTION

The present invention relates generally to a product recovery system (PRS), and more particularly to a product recovery system for the recovery of residual raw or processed food or feed from processing plant lines and equipment.

### BACKGROUND OF THE INVENTION

Large-scale commercial food processing plants have the problem of processing losses and biological waste. Processing losses can result from spills, spoiled product, product that does not conform to quality and or legal standards, and processing residues left in the equipment. In particular, when processing residues are disposed as waste, the efficiency and profitability of food processing decrease, and the cost of disposal and waste treatment increase. Unfortunately, existing attempts to utilize or reduce processing residues, or minimize disposal costs, have not been satisfactory.

Residues are created when fluid or solid foods are processed, transported, stored, and conveyed throughout the processing plant. Residues exist in tankers, trucks, rail tank cars, tanks, silos, vats, and other storage vessels, including the pipes and pumps used to convey the fluids or solid food.

Examples of fluid food products residues include milk, drinks and juices, along with thicker fluid foods, for example yogurt, sour cream, condiments (such as ketchup, mustard, relish, and sauces), and solid food products include preserves, jellies, frozen food products like ice cream, grains, and animal feed.

Another problem in the food processing industry is the environmental impact of food waste. For example, in the cheese manufacturing industry as much as 90% of the incoming milk volume remains as whey after processing. Residual whey is a major source of biochemical oxygen demand (BOD) and very costly to dispose as waste or sewage due to the discontinued use of land application disposal. Residual whey is also difficult to store and expensive to process, despite the value of the lactose, protein, and minerals contained in the whey. As a consequence, it is costly for cheese plants to have equipment for recovering, utilizing, or treating product residue.

Unsuccessful attempts to address the problem of residue recovery include the use of compressed air, and line cleaning devices known as “pigs” for clearing equipment lines. These methods are not effective, particularly for large or open equipment. Other systems include treating the waste stream by means of chemical or enzymatic treatment. Because of this continuing problem of disposal and the need to increase efficiency in sanitary recovery and production profits, there is a long felt need for a solution to recover residual product in the food product processing industry.

### SUMMARY OF THE INVENTION

The present invention is a product recovery system for recovering residual product in food processing equipment and the lines connecting such equipment.

In one aspect of the invention, a product recovery system includes a controlled supply of fluid or solid matter that is connected to the lines of a processing plant. The fluid or solid is used to displace product or a product residue in the equipment or its connecting lines. At least one sensor is placed in communication with the recovered product. The sensor measures a predetermined characteristic of the recovered product and sends a signal to a controller to control the supply of fluid or solid as a function of the received signal. A balance tank is used to collect the recovered product.

This invention is used for processing plants and related equipment, particularly for fluid food processing such as the fluid dairy product processing industry. The system may be employed at the conclusion of normal food processing operations and before sanitation operations such as cleaning-in-place (CIP).

In one of its several aspects, the invention includes a controlled fluid that is treated and temperature controlled, such as treated chilled potable water. In a particular embodiment, the treated chilled potable water is maintained at a temperature below 45° F. The fluid is treated with either heat, chemical, ionizing radiation, sterilization, filtration, ozone, or ultraviolet light. In another aspect, the fluid is introduced by a Clean-in-Place (CIP) system, which is commonly used in the food processing industry. In another aspect, solid matter is pelletized plastic maybe used when solid food is the subject of recovery.

In another aspect of the invention, the product recovery system includes at least one Pasteurized Milk Ordinance (PMO) approved mix-proof valve and a balance tank. PMO refers to the United States Department of Health and Human Services Grade “A” Pasteurized Milk Ordinance. The PMO valve is used to connect at least one line of the processing plant to the controlled supply of fluid, a CIP system, or a balance tank, or any combination thereof. In addition, a controller is used to control the PMO valve, and may be used to prevent or inhibit the operation of the CIP system during product recovery cycles.

In a particular embodiment of the product recovery system, the PMO valve and balance tank are combined to form a sanitary recovery of Grade A milk product. In another aspect, the balance tank has at least one non-submerged entry port for receiving recovered product. The balance tank may also be insulated, mechanically agitated, and refrigerated. The system may also include a temperature control system, a heat exchanger, and a recovery tank for collecting the recovered product from the balance tank.

In another embodiment, the present invention provides a method of recovering product from a processing plant. The method includes the steps of controlling a supply of fluid connected to the lines of a processing plant, displacing a product contained within the lines with the fluid; receiving, with a controller, a signal from at least one sensor in communication with the recovered product, controlling the supply of fluid as a function of the received signal, and collecting the recovered product in a balance tank.

In another aspect of the invention, the method includes a controller for controlling at least one PMO-approved mix-proof valve. The controller also prevents the operation of the CIP system as the product is recovered, in another aspect of the method. The method also provides for the recovery of Grade A milk product. These and other objects and advantages of the present invention will be apparent from the drawings, the description of the embodiments, and the claims.

### BRIEF DESCRIPTION OF THE DRAWINGS

For the purpose of illustrating the invention, there is shown in the drawings a form which is presently preferred; it being understood, however, that this invention is not limited to the precise arrangements and instrumentation shown, but rather can be modified or alternatively implemented in a variety of ways.

FIG. 1 is an illustration of a product recovery system according to the present invention.

FIG. 2 is an illustration of a process flow chart of a method for a product recovery system according to the present invention.

FIG. 3 is an illustration of a product recovery system according to the present invention for a High Temperature Short Time (HTST) Pasteurization Unit.

FIG. 4 is an illustration of a product recovery system adapted to a vacuum dispenser.

FIG. 5 is a product recovery system adapted to a plurality of controlled processing stations.

### DETAILED DESCRIPTION OF THE INVENTION

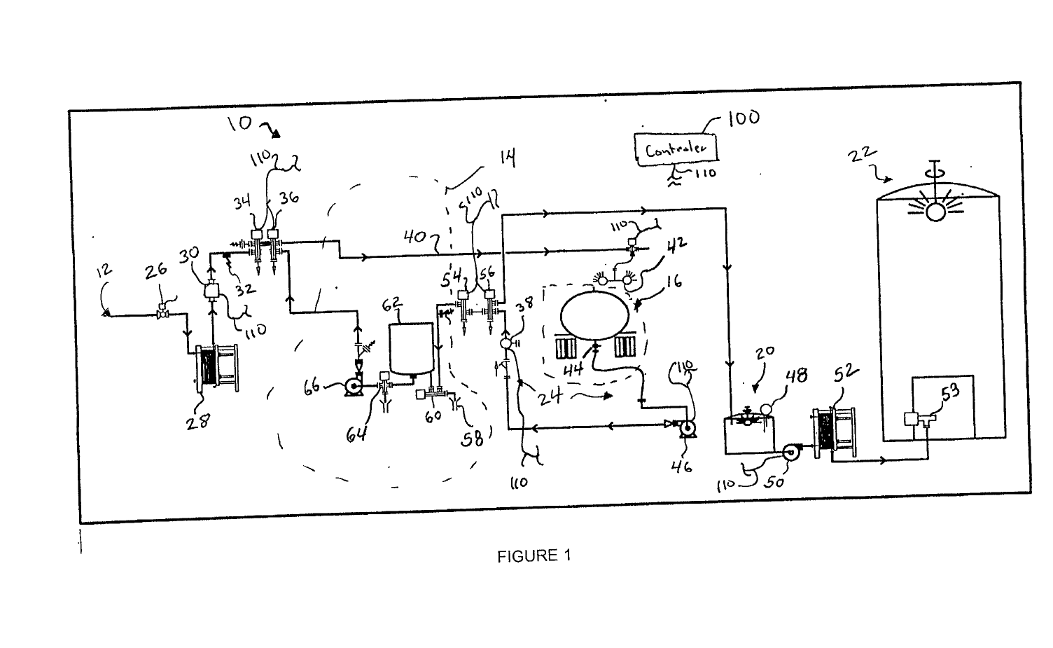

Referring to the drawings, wherein like numerals indicate like elements, there is shown in FIG. 1 an illustration of a product recovery system (PRS) 10 for recovering raw product residue from a food processing plant such as a fluid milk plant, ice cream plant, cheese plant, and their related equipment.

The PRS 10 includes a supply of fluid or solids 12 such as potable water or pelletized plastic used to recover the desired food product. The PRS system also includes an optical detector 38, a balance tank 20, and a recovery tank 22. When applied to a fluid milk processing plant, residual milk is recovered from the plant and processing equipment 16 or related equipment. Although FIG. 1 illustrates a tanker 16, it is understood that the equipment 16 may include, but is not limited to, processing equipment, tankers, transfer lines, silos, or High Temperature Short Time (HTST) pasteurizing units or some combination and plurality thereof. In addition, the PRS 10 may be adapted to a conventional Clean-In-Place (CIP) system 14.

For example, the PRS 10 is connected to a tanker 16 by means of a conventional CIP system 14. A potable water supply 12 is connected to the CIP system 14 through a valve 26. In a preferred embodiment, the equipment associated with the PRS 10 is of a 3A sanitary and PMO standard for Grade A milk products. In addition, in the preferred embodiment the water is chilled to a desired temperature by means of a refrigeration or heat exchanger system 28 and the water is of sufficiently high quality to be free of chemical contaminants and treated with by heat, ozone, or filtration to remove microbial contamination. The treated and chilled water allows the recovered milk product to be collected in a sanitary manner and reused in another milk product.

In one aspect of the invention, a flow meter 30 measures the amount of fluid fed into the processing equipment 16. A pressure sensor 32 is used to monitor fluid pressure.

Chilled treated water is fed into the PRS 10 through a first valve 34 and a second valve 36 to ensure proper flow direction and isolation between product recovery lines and CIP lines. The first and second valves 34,36 are of a type meeting Pasteurized Milk Ordinance (PMO) standards, which are controllable by a programmable controller 100 connected to the valves, pumps and sensors by connector 110. The first and second valves 34,36 are regulated by a feedback control signal from the flow meter 30, pressure sensor 32, or an optical sensor 38.

The treated water enters through line 40 of the CIP system 14. The water is injected into the equipment to remove residual product. For example, the water is sprayed by a series of spray balls 42 that are placed inside the tanker 16. The chilled treated water flushes the raw milk product out of the tanker 16 through outlet port 44. A pump 46 is used to move the recovered milk past the optical sensor 38 for detection of milk solids. The residue milk product is then captured by a recovery tank 20. The optical sensor 38 is used to detect a pre-determined condition of the recovered milk such as, but not limited to, milk solid content. The optical sensor 38 generates a signal that is received by the controller 100, which regulates the first and second valves 34 and 36 controlling the flow and direction of the recovered milk. It is to be understood that other detectors and criteria may also be used, such as temperatures and pressures.

The flow of the recovered milk is directed to either a recovery balance tank 20 or discarded depending on the pre-determined condition measured by the optical sensor 38. If the measurement sensed by the optical sensor 38 is within a desired predetermined level, the flow is diverted to an insulated balance tank 20. The balance tank 20, meeting 3A or PMO standards, is outfitted with a level probe or level sensor 48 for activating a pump 50 when a desired level is reached. The recovered raw milk is pumped through a heat exchanger 52 to adjust the temperature of the recovered milk as it is transferred to a milk recovery tank 22. When the measurement made by the optical sensor 38 is outside a desired range, the flow of diluted product is diverted to a drain 58.

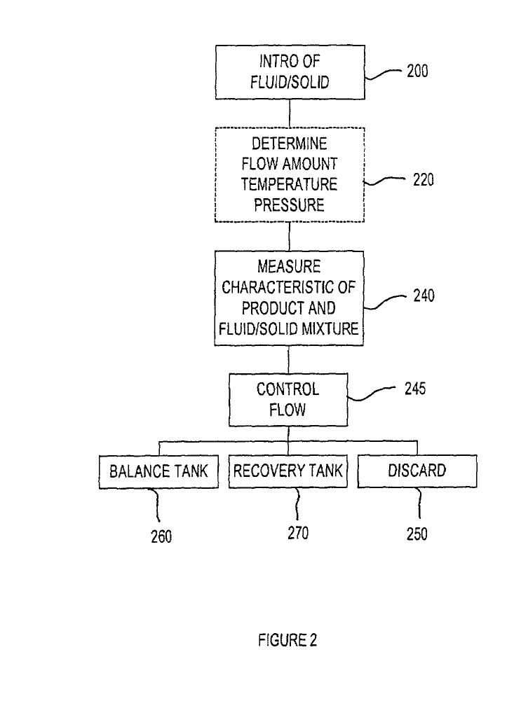

FIG. 2 illustrates a process flow chart of a recovery process according to one aspect of the invention. Chilled treated potable water is introduced 200 in the equipment or lines associated with a product recovery system 10. The water enters the system 10 through a CIP circuit 14 by means of a pair of mix-proof sanitary valves 34,36. Optionally, the amount, temperature and pressure of the water is determined 220 by a flow meter 30 and its temperature is adjusted as required. The water displaces raw product from the equipment and the lines in the system 10. An optical sensor 38 measures 240 the recovered raw product, and allows the recovered raw product to be collected provided it meets predetermined criteria, such as a desired milk solid level. The collection process may be terminated by a predetermined limit determined from the optical sensor 38, flow meter 30, temperature, or other process data. The flow of product fluid/solid is directed, controlled and diverted 245 to either a balance tank for sanitary reuse 260, storage recovery 270 by a tank, or discarded 250. It is understood that the recovered product in the balance tank is delivered to a recovery tank for further processing. It is also to be understood that the product discarded for human consumption may also be diverted to a recovery container for animal consumption. In this embodiment, the discard step includes a recovery container for further processing.

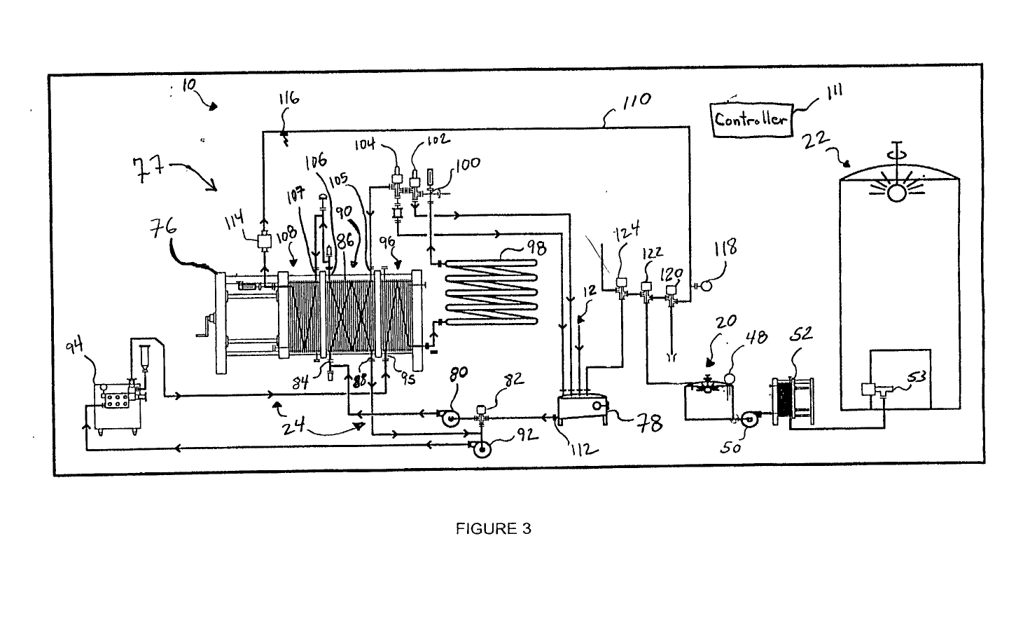

FIG. 3 illustrates a product recovery system 10 connected to a High Temperature Short Time (HTST) pasteurizer unit 77. The milk flows through connecting lines to an HTST balance tank 78. Cold raw milk from the HTST balance tank 78 is delivered to a pump 80 through a valve 82 to a first entry point 84 of a product-to-product regeneration section 90 of the heat exchanger unit 76.

Incoming cold milk is heated by outgoing heated pasteurized milk on the opposite side of the heat plates 86. Upon exiting at a first exit point 88 of the regeneration section 90 of the heat exchanger unit 76, the heated unpasteurized milk is pumped by a pump 92 through a homogenizer 94 to a heating section 96 of the heat exchanger unit 76. After reaching an established temperature for an established time in the holding tube 98, properly pasteurized milk passes through the divert valve 102,104 and temperature sensor 100. The milk continues on to a product-to-product regeneration section 90 of the heat exchanger unit 76 where it is cooled by incoming cold raw milk.

The milk exits the regeneration section 90 through exit point 106. The warm pasteurized milk is then chilled upon entering a third entry point 107 and passing through a cooling section 108 of the heat exchanger unit 76. Chilled pasteurized milk is then transported through a transport line 110 to a storage tank (not shown). Inadequately pasteurized milk is automatically diverted by the measurement of temperature sensor 100 detected by controller 111 controlling valve 102 which diverts the milk back to the balance tank 78 for reprocessing.

In another aspect of the invention, the product recovery system 10 operates during a change over from one product to another, by flushing the product from milk to water or water to milk in a forward flow condition. Potable water enters the balance tank 78 from a source 12. The flow of the water flushes the milk from the balance tank 78, and the flushed milk is transported through the processing lines 24 and the product-to-product regeneration section 90 of the heat exchanger unit 76. As the recovered product exits the regeneration section 90 it is sent through a holding tube 98 and temperature sensor 100.

The pasteurized product passes through the second side of the regeneration section 90, into the cooling section 108 of the heat exchanger unit 76. The chilled product exiting the heat exchanger 76 is monitored by one or more flow meters 114, a pressure sensor 116, or an optical sensor 118. In a preferred embodiment, the valves 120,122,124 are sanitary valves. The valves 120,122,124 are controllable by a programmable controller 100, which are regulated by a variety of signal feedback mechanisms carried by connection 110. The feedback mechanisms include signals from the pressure sensor 116, the flow meter 114, or the optical sensor 118.

If the flushed product meets pre-determined standards such as milk solids, temperature, or pressure, the controller 110 controls the valves 120,122,124 to direct the flow of flushed product to balance tank 20 for holding. The balance tank 20 meets current PMO standards and is outfitted with a level probe or level sensor 48 which activates a pump 50 when the desired level is reached. The pump 50, when activated, pumps the recovered product through an optional heat exchanger 52 to adjust temperature prior to passage into a bulk pasteurized recovery tank 22 through port 53.

If the recovered product fails to meet a predetermined characteristic, the flow is diverted through valve 120 to a drain, or recycled through balance tank 78 for some other purpose.

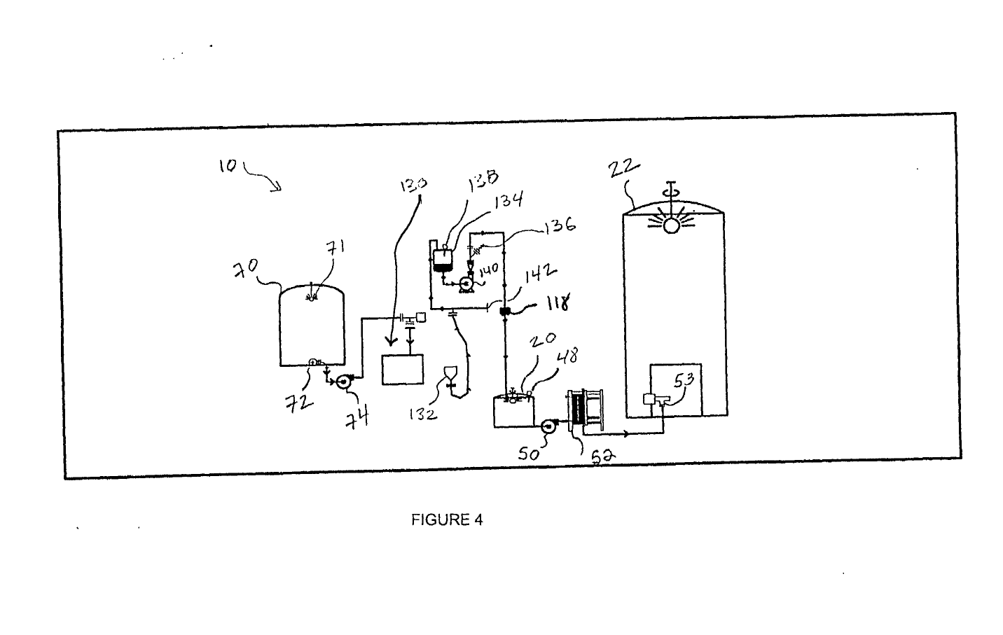

FIG. 4 illustrates a product recovery system 10 for recovery of pasteurized milk residue from packaging equipment, such as a filling machine found in many dairy processing plants.

Milk from a pasteurized milk tank 70 flows through an outlet port 72 and is pumped by a pump 74 to a filling line equipment 130 for filling containers. At the conclusion of processing and packaging, or prior to changeover of the filling equipment 130 from one product type to another, product is typically lost to the waste disposal system or sewer drains. This includes product that is located within the filler bowl and the residual product in a filler receiving tank 132. The system of the present invention overcomes the problems of lost product and sewer discharge.

Vacuum is maintained in a vacuum vessel 134 by means of a vacuum pump (not shown). The milk product residue from the filler receiving tank 132 is suctioned into the vacuum vessel 134. A temperature sensor 136 monitors the temperature to ensure that the temperature is maintained at or below 45° F.

A level probe 138 on the vacuum vessel 134 control a filler pump 140, which conducts the product residue as it is measured for a predetermined characteristic by an optical sensor 118. The product residue is divided to a to an insulated jacketed balance tank 20 for holding. The balance tank 20 meets current PMO standards and is outfitted with a level probe 48 which activates a pump 50 when desired level is reached. The pump 50, when activated, pumps the recovered milk product through a heat exchanger 52 to adjust temperature prior to passage into the milk product recovery tank 22 through an inlet port 53.

Chilled treated potable water enters from a source (not shown), through line 142. flow of the chilled treated water displaces a remaining milk product which flows through the filling equipment 130 to the balance tank 20 and on to the recovery tank 22. Product residue from the milk tank 70 is recovered as previously described by flowing a chilled treated water through a spray ball 71 and recovering the product accordingly.

Although the examples provide for the invention are for use in dairy processing plants, the system and method of the instant invention are not limited to such and are useful in any processing plant wherein there are product residues which may be recovered and collected according to the methods described herein. Processing plants in the food industry are particularly of utility with respect to the invention disclosed. Applicable fluid processing and transport operations in other industries include pharmaceutical, biotechnological, petrochemical, agrochemical and industrial chemical operations.

For the purposes of this disclosure, the term fluid as applied to fluid processing includes liquids, gases, plasma, supercritical fluids, and solids which behave as fluids, or have properties of fluids, such as fluidized materials, or materials which have properties of flow or flow characteristics under one or more set of conditions as may be achieved in a processing operation. In addition the term fluid as applied to a controlled supply of fluid for displacing product includes any of the above mentioned fluids, or mixtures of the above, or the any of the above fluids with additives useful in displacing or recovering a product residue from a processing plant.

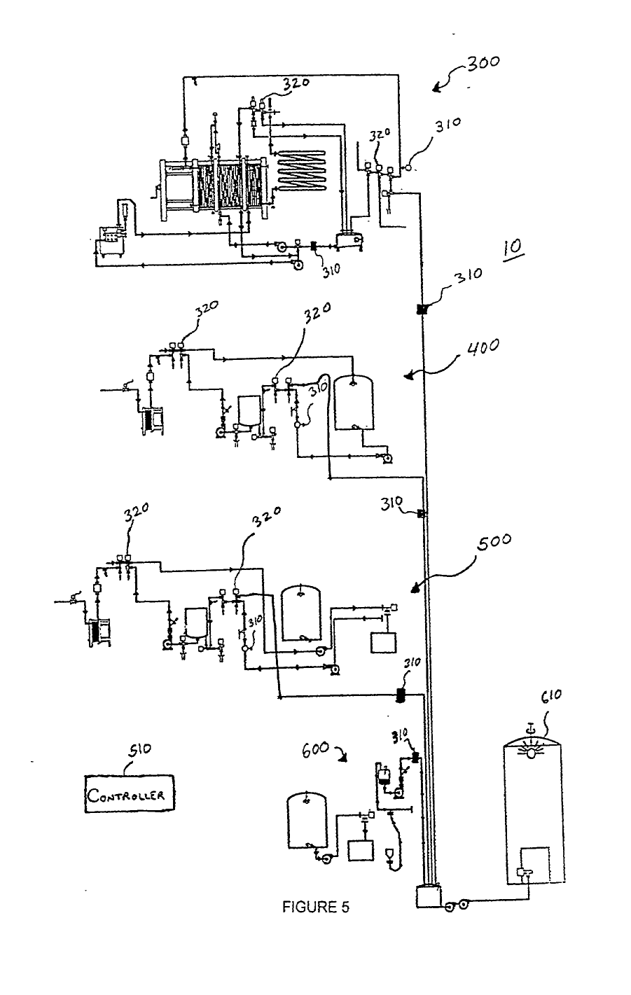

FIG. 5 illustrates a PRS 10 having a plurality of recovery stations 300, 400, 500, 600 comprising individual complex processing plant operations. The PRS 10 controls the plurality of processing stations by means of a controller 510, plurality of sensors 310, and plurality of control valves 320. Control 510 controls the valves 320 to allow recovered product to flow into a storage recovery tank 610 when the recovered product meets a predetermined characteristic as measured by sensors 310 and analyzed by controller 510.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed:

1. An automated product recovery system comprising:
a controlled supply of fluid or solid matter connected to the lines or equipment of a processing plant, the fluid or solid matter used to displace product contained within the lines or equipment;
at least one sensor in communication with the recovered product, the sensor for measuring a predetermined characteristic of the recovered product;
a controller for receiving a signal from at least one sensor and for controlling the supply of fluid or solid matter as a function the received signal; and
a balance tank disposed to receive the recovered product.

2. The system of claim 1, wherein the fluid is treated and chilled potable water.

3. The system of claim 1, wherein the solid matter is pelletized plastic.

4. The system of claim 1, wherein product recovery system utilizes components of a CIP system.

5. The system of claim 1, wherein the balance tank is connected to the product recovery system by a plurality of PMO-approved mix-proof valves or sanitary valves.

6. The system of claim 1, further comprising at least one PMO-approved mix-proof valve connected to at least one line of the processing plant and the controlled supply of fluid, or a CIP system, or a balance tank, or some combination thereof.

7. The system of claim 4, wherein the at least one PMO valve is controlled by the controller.

8. The system of claim 6, wherein the controller prevents the operation of the CIP system when product is recovered.

9. The system of claim 1, wherein the product recovered is Grade A milk product.

10. The system of claim 1, wherein the balance tank is insulated and refrigerated.

11. The system of claim 1, wherein the balance tank has at least one non-submerged entry port for receiving the recovered product.

12. The system of claim 1, wherein the fluid is treated and chilled potable water maintained at a temperature below 450 F.

13. The system of claim 1, wherein the fluid is treated by a method selected from the group consisting of heat treatment, chemical treatment, ionizing radiation, sterilization, sterile filtration, ozonation, and ultraviolet treatment.

14. The system of claim 1, further comprising a temperature control system.

15. The system of claim 1, further comprising a recovery tank for collecting the recovered product from the balance tank.

16. The system of claim 14, further comprising a heat exchanger.

17. The system of claim 1, wherein the at least one sensor is selected from the group of temperature sensors, solids analyzers, infrared analyzers, flow meters, flow detectors, pressure sensors, timers, position detectors, fluid level probes, optical sensors, spectroscopic detectors, pH meters, event sensors, fault sensors, vacuum detectors, force detectors, microwave sensors, ultrasonic sensors, light sensors, fiber optic sensors, and bioluminescence detectors.

18. The system of claim 1, further comprising PMO-approved mix-proof valves.

19. A method of recovering product from a processing plant comprising the steps of:
controlling a supply of fluid connected to the equipment or lines of the processing plant;
recovering the product by flushing the equipment or lines with the supply of fluid;
receiving a signal from at least one sensor in communication with the recovered product;
controlling the supply of fluid as function of the received signal; and
collecting the recovered product in a tank.

20. The method of claim 19, wherein the fluid is treated.

21. The method of claim 19, wherein the fluid is chilled potable water maintained at a temperature below 45° F.

22. The method of claim 19, wherein the method of recovering product utilizes components of a CIP system.

23. The method of claim 19, further comprising the step of operating at least one PMO-approved mix-proof valve.

24. The method of claim 23, wherein the at least one PMO valve is controlled by the controller.

25. The method of claim 24, wherein the controller prevents the operation of the CIP system when product is recovered

26. The method of claim 19, wherein the product recovered is Grade A milk product.

27. The method of claim 19, wherein the balance tank is insulated and refrigerated.

28. The method of claim 19, wherein the balance tank has at least one non-submerged entry port for receiving the recovered product.

29. The method of claim 19, further comprising the step of receiving the recovered product from the balance tank into a recovery tank.

30. The system of claim 1, wherein all components meet a 3A sanitary and PMO standard for Grade A milk products.

31. The method of claim 19, wherein each step is maintained in a pasteurized condition allowing the change of product without the need for a CIP step.
